(19) United States
(12) Patent Application Publication
(10) Pub. No.: US 2023/0264871 A1
(43) Pub. Date: Aug. 24, 2023

(54) Item Deposition Unit and Reusable Delivery Container

(71) Applicant: Recyclabox Limited, London (GB)

(72) Inventors: Thomas Bradbury Williams, London (GB); James Michael Seear, London (GB)

(21) Appl. No.: 18/027,559

(22) PCT Filed: Sep. 22, 2021
(86) PCT No.: PCT/GB2021/052459

§ 371 Date: Mar. 21, 2023

(30) Foreign Application Priority Data
Sep. 22, 2020 (GB) 2014949.8

(51) Int. Cl. B65D 55/14; G07C 9/00

(52) U.S. Cl. CPC B65D 55/14; G07C 9/00896; B65D 2203/10; G07C 2009/0092

(57) ABSTRACT

A reusable delivery container comprising an enclosure for containing an item; a closure selectively allowing access to the enclosure; a display on an outer surface of the container, comprising configurable electronic ink for displaying delivery information; an electronic lock for selectively securing the closure, the electronic lock having updatable unlock criteria; a receiver configured to receive data communications, the data communications comprising at least lock data; power circuitry for providing power from a power source to the display, the electronic lock, and the receiver; and control circuitry arranged to control the electronic lock and update the unlock criteria, based on lock data received by the receiver.

### TECHNOLOGICAL BACKGROUND

Delivery of items conventionally takes place using delivery containers made of cardboard, plastic, or other disposable materials, with these materials being typically used only once. In order for the postal or courier services to know the intended destination for the items, information is typically printed, stamped, or hand-written onto the delivery containers or adhesive labels attached to the containers. These labels are also disposed of after delivery, once they have served their purpose. Therefore, to reduce the environmental impact of this process, these containers and labels may be made from recyclable materials.

Furthermore, if secure delivery of items is desired, conventional postal or courier services cannot be trusted to ensure delivery containers are not opened and, therefore, it is typical to use end-to-end security companies for collection, transportation and delivery of valuable items. In essence, a locked box containing the items is escorted by a security professional from sender to recipient, being unlocked on delivery. Examples of these systems include so-called ‘cash-in-transit’ boxes and the like.

As such, delivery containers are prevalent in everyday use, improvements in these delivery containers are both desired and required.

Users of items such as electronic devices often dispose of the devices at the end of their use lifetime. A number of online marketplaces offer exchanges for such devices and therefore users can be dissuaded from disposing of the devices in landfill thereby contributing to a growing problem of electronics waste. When using these online marketplaces, the user will post their device to a centralised distribution centre of the online marketplace or directly to a purchaser of the device, using a delivery service. In order to ensure secure delivery of valuable devices, a premium secure delivery service can be employed such as those discussed above.

### SUMMARY

Viewed from first aspect there is provided a reusable delivery container comprising an enclosure for containing an item; a closure selectively allowing access to the enclosure; a display on an outer surface of the container, comprising configurable electronic ink for displaying delivery information; an electronic lock for selectively securing the closure, the electronic lock having updatable unlock criteria; a receiver configured to receive data communications, the data communications comprising at least lock data; power circuitry for providing power from a power source to the display, the electronic lock, and the receiver; and control circuitry arranged to control the electronic lock and update the unlock criteria, based on lock data received by the receiver.

By employing electronic ink in a label display, so as to create a so-called ‘e-label’, the label can be reused multiple times. The e-label can be updated with new delivery information before or during a delivery process and requires very little or even no power to maintain the displayed delivery information. In certain examples, the container is configurable to require no power during transport. This advantageously allows for any delivery or courier service to be able to securely transport the container.

Furthermore, the reusable delivery container is highly reusable by virtue of the closure selectively allowing access to the enclosure and the use of an e-label. Therefore, the amount of packaging waste in a delivery system using the container can be greatly reduced. As a further advantage, the energy intensive recycling process is not required.

Moreover, the use of an electronic lock having updatable unlock criteria greatly improves the security of a reusable delivery container. As is described in more detail below, the present invention may allow for only a recipient - not the sender or delivery service - to have knowledge of the unlock criteria to unlock the container. Therefore, the cost and difficulty of transporting valuable goods can be reduced.

According to an example, the receiver is further configured to receive delivery data, the control circuitry is arranged to control the display, and the control circuitry is further configured to update the displayed delivery information based on received delivery data.

By updating the delivery information using delivery data provided to the receiver of the container, the container can be transported from location to location, having the delivery information updated remotely or locally, without the need to transport the container back to a delivery depot (who may be in possession of the delivery data for the next recipient). Instead, the e-label can be updated to display the next recipient’s delivery information by, for example, a user currently in possession of the container. Thus, the number of trips made by the container during its life can be reduced. In turn, this reduces the environmental impact of a delivery system employing such containers.

According to an example, the electronic lock is configured to adopt an unlocked state in response to the receiver receiving unlock data that satisfies the unlock criteria.

By unlocking the container using unlock data transmitted to the receiver, the privacy of unlock data entry can be enhanced. Therefore, the unlock criteria can remain as being known only to a given user, if desired.

According to an example, the reusable delivery container further comprises a location sensor, wherein the unlock criteria comprise at least one unlock location, and the control circuitry is configured to unlock the electronic lock upon a determination by the location sensor that the delivery container is within a predetermined radius of the at least one unlock location.

This further enhances the security and convenience of the container, as it is possible to automatically unlock the container upon arrival at an intended location. If the containers are integrated into a scaled operation involving many such containers, this greatly increases the delivery throughput of the operation.

According to an example, at least one of: the at least one unlock location; and, the predetermined radius of the at least one unlock location, are provided as lock data to the receiver.

In this option, both the GPS location but also the specificity of GPS radius can be changed per delivery. This may be advantageous for deliveries which include both countryside and inner city deliveries, where the distance between delivery destinations and nearest neighbours is changeable. The specificity of the GPS need not be so strict where buildings are spaced further apart, thereby reducing the need for high position location accuracy on specific deliveries.

According to an example, the control circuitry comprises data storage means with one or more lock data stored thereon, and the control circuitry is arranged to update the unlock criteria based on the one or more lock data stored on the data storage means.

The container, having lock data stored thereon (i.e. additionally to the current unlock criteria), can iterate or cycle between these different unlock criteria. Therefore, maintained contact with a wider network is not necessary and the container can be employed in more real-world settings, such as where connection with a network may be inconsistent. The flexibility of use of the container is therefore greatly increased.

Viewed from a second aspect, there is provided an electronic delivery system comprising at least one reusable delivery container according to the first aspect, an item deposition unit, wherein the item deposition unit comprises a casing at least partially surrounding a cavity, the cavity arranged to receive the at least one reusable delivery container; an item deposition channel for communicating items from an exterior of the casing to the enclosure of the at least one delivery container; and management circuitry configured to exchange data communications with the receiver of the at least one delivery container.

By providing a communal place to deposit items, fewer delivery trips are required to distribute the items. Therefore, the environmental impact of an item recycling scheme can be reduced.

Furthermore, in cases where payment is offered in return for the deposition of items, an instantaneous payment for items can be provided because they have been securely received by the unit, so the transaction between the user and the manager of the item deposition unit is complete once items have been deposited.

A further advantage provided to users is that they do not need to pay for secure postage to recycle or sell their items. Instead, the system automatically applies delivery information to a screen on the reusable delivery container for collection by any delivery service, the container being locked by an electronic lock with updatable unlock criteria.

According to an example, the management circuitry is further configured to provide lock data, an unlock location, unlock update instruction and/or the delivery information update instruction to the receiver of the at least one reusable delivery container.

The system can be configured to apply lock data, unlock location or locations, delivery data and/or unlock criteria so that management of delivery of items can be entirely self-contained within the system. This provides a more reliable delivery system with a single co-ordinator. Similarly, this advantageously provides a more secure system with one entity able to manage the unlock criteria of the container.

According to an example, the item deposition unit comprises a reader for collecting information about items and communicating the information to the management circuitry.

Using a reader to collect information about items deposited into the system allows the system to detect the items that are being deposited. Advantageously this removes a requirement for the user to provide information about their deposited devices. Therefore, the system can either detect directly or confirm (e.g. from an earlier user submission) the identity of the items deposited, thus improving the security of the system.

According to an example, the reader is arranged in the item deposition channel.

By integrating the reader into the item deposition channel, detection of the item can occur as the item is being processed in the system. In this way, a first item could not be detected by the system and then removed from the system by a user and replaced with a second item. Therefore, the robustness of the system is improved. A delivery service can therefore be provided with greater certainty that the items allegedly contained in the container are actually there. This improves the reliability of a delivery system.

According to an example, the at least one reusable delivery container contains a plurality of closures, each closure selectively allowing access to a corresponding enclosure, the plurality of closures of the at least one reusable delivery container and an exit of the item deposition channel are arranged to move relative to one another, and the plurality of closures and the exit of the item deposition channel are move relative to one another in response to a selection message from the management circuitry to direct the exit of the item deposition channel toward a selected closure.

Having a selection of enclosures enables items to be sorted into different enclosures for effective weight distribution or other criteria. For example, items can be sorted according to value or containers can be filled in series according to the next available container, so that containers can be rotated in and out of the item deposition unit.

According to an example, the selection message is based at least in part on collected information from the reader.

Linking the selection message, which co-ordinates an effective sorting of items, with information collected by the reader means that items can be sorted based on more nuanced properties such as value, likelihood of purchase etc. Additionally or alternatively, the information collected from a set of items can be associated with the container that the set of items has been directed toward. Thus, the container containing this set of items may be configured to display information about the set of items on its display, said information being provided to the receiver of the container from the reader via the management circuitry. Thus, delivery services can be automatically informed as to the nature of the contents of a given container.

According to an example, at least one of the plurality of closures is provided with a different unlock criteria to at least one of the other closures.

In cases with multiple enclosures, specific enclosures can be provided with different unlock criteria, so that access to one enclosure does not mean access to all enclosures. In this way, a user or a recipient or handler can be selectively locked out of particular enclosures, for example those enclosures holding high value items. This increases the versatility and of the system by having more finely grained security requirements.

Viewed from a third aspect, there is provided an electronic delivery method comprising receiving one or more items at an item deposition station; communicating the items to one or more reusable delivery containers, each of the one or more reusable delivery containers being a container according to the first aspect of the invention; locking the one or more delivery containers with updatable unlock criteria provided to the one or more containers; providing delivery data to the one or more containers; displaying delivery information on the one or more containers; and transporting the one or more containers to a first location corresponding to the delivery information.

In accordance with this aspect, a secure, convenient and inexpensive method is provided that allows third party delivery services, with no particular premium security offerings, to be used for the transportation of valuable items.

### BRIEF DESCRIPTION OF THE DRAWINGS

One or more embodiments of the invention will now be described, by way of example only, and with reference to the following figures in which:

FIG. 1A shows a schematic view of an reusable delivery container according to an example of the present invention;

FIG. 1B shows a perspective view of an reusable delivery container according to an example of the present invention;

FIG. 2A shows a schematic cross-sectional view of the reusable delivery container from FIG. 1, according to an example;

FIG. 2B shows the reusable delivery container of FIG. 2A with the closure opened to receive an item;

FIG. 3 schematically shows a delivery system according to an example;

FIG. 4 schematically shows an item deposition unit, according to an example of the invention;

FIG. 5A shows a side-on schematic view of the item deposition unit from FIG. 4, according to an example of the invention;

FIG. 5B shows a side-on schematic view of the item deposition unit from FIG. 4, according to another example of the invention; and

FIGS. 6A-6C show views of an item deposition unit and a reusable delivery container, according to another example of the invention.

### DETAILED DESCRIPTION

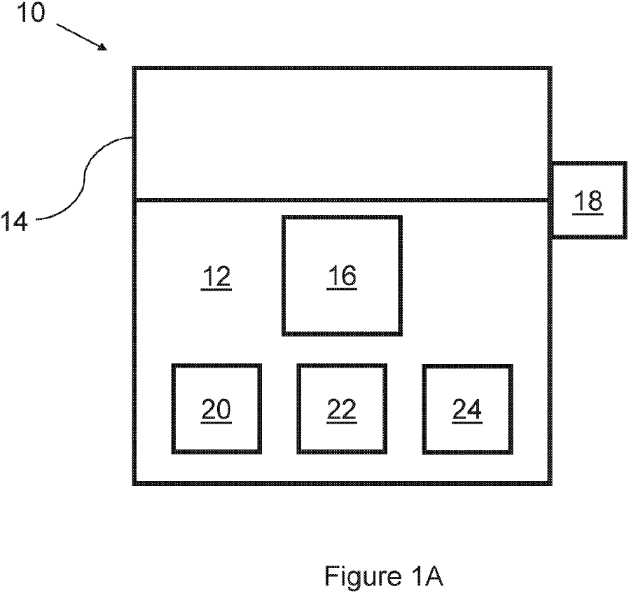

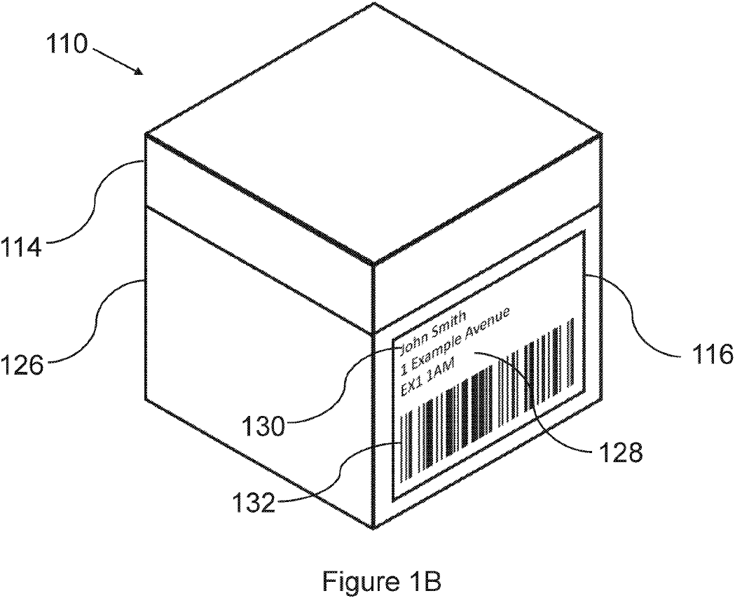

FIG. 1A shows a schematic view of a reusable delivery container according to an example of the present invention. In the illustrated example, there is shown a reusable delivery container 10 (also referred to as a delivery container or simply ‘container’) having an enclosure 12 for containing an item. The delivery container 10 also includes a closure 14 selectively allowing access to the enclosure 12. In the shown example, the container 10 is in a closed position. The reusable delivery container is also shown with a display 16 on an outer surface of the container 10, comprising configurable electronic ink for displaying delivery information (not shown).

The closure 14 may be an access door, a movable panel, or the link and may be attached to the container 10 when in an open position or may become detached from the container 10 when in an open position.

An electronic lock 18 for selectively securing the closure 14 is shown attached to the closure 14. The electronic lock 18 has updatable unlock criteria that, when satisfied, cause the electronic lock to adopt an unlocked state. The reusable delivery container 10 also comprises a receiver 20 configured to receive data communications and power circuitry 22 for providing power from a power source to the display 16, the electronic lock 18, and the receiver 20. The illustrated container 10 also comprises control circuitry 24 arranged to control the electronic lock 18 and, optionally, the display 16 and the receiver 20. Whilst the receiver 20, the power circuitry 22 and the control circuitry 24 are shown schematically as disconnected boxes in FIG. 1A, these may be connected through wired or wireless means using appropriate electronics.

The display 16 comprises configurable electronic ink for displaying delivery information. The term “electronic ink” is meant to encompass any display technology that requires no or very low power to maintain its display, for example microencapsulated electrophoretic display technology. Therefore, by using electronic ink, the overall power consumption of the container 10 can be greatly reduced.

The electronic lock 18 may be any mechanism suitable for securing the enclosure 12 by securing the closure 14 a closed position. The electronic lock 18 comprises unlock criteria that, when satisfied, cause the electronic lock 18 to adopt an unlocked state. The electronic lock 18 is electronic in the sense that it comprises electronics that, at least, allow for the maintenance and updating of unlock criteria. For example, the electronic lock 18 can be a padlock having means for entering a passcode, password or the like. In this specific example, the unlock criteria may be the entry of a correct passcode.

The electronic lock 18 may be unlocked by some physical or electronic master key in the case of unlock criteria being forgotten, corrupted, or otherwise lost. The person skilled in art will appreciate that various fail-safes can be introduced at the expense of system security, or fail-safes can be removed with an increased risk that an item can become irrecoverably locked inside the container 10.

The receiver 20 is configured to receive data communications. These may be wired or wireless data communications. For example, the receiver 20 can include a wired data input means such as a USB, micro-USB, Ethernet or other data port capable of transferring data.

Additionally or alternatively, the receiver 20 can be configured to receive short-range or long-range wireless data communications. For example, the receiver 20 can be configured to receive Bluetooth® communications, Wi-Fi® communications, Near-Field Communications (NFC), Long-Term Evolution (LTE®) communications or the like.

In some examples, the receiver 20 can also comprise a transmitter. That is, the receiver 20 may be a transceiver 20. In these examples, the receiver 20 may be configured to exchange data communications with another device, such as a user device, to confirm satisfaction of the unlock criteria, confirm update of the delivery information, or for other such purposes.

The control circuitry 24 is arranged to control the electronic lock 18 and, optionally, the display 16, and/or the receiver 20.

The display 16 includes configurable electronic ink and, therefore, the control circuitry 24 may be optionally arranged to configure and re-configure the electronic ink so as to display delivery information. Such control may not be necessary in example cases where the display 16 is detachable and updatable by some other means.

The control circuitry 24 may include data storage means for storing one or more instances of delivery information. For example, multiple pieces of delivery information, representing multiple destinations along a delivery route, can be concurrently stored in the data storage means of the control circuitry 24. Upon updates of the delivery information, the control circuitry 24 can fetch the next piece of queued delivery data and re-configure the electronic ink of the display 16 to display updated delivery information based on the fetched delivery data. The re-configuration of electronic ink, as described above, is not energy intensive and therefore this is an efficient method for updating delivery information.

Alternatively, the control circuitry 24 can be arranged to monitor receipts at the receiver 20 of update messages. Upon receiving an update message, the control circuitry 24 may generate or relay a control signal to the display 16 to update the delivery information from the received update message. By not requiring excessive data storage in the reusable delivery container 10, the cost of manufacture of the container 10 can be reduced.

Similarly, the control circuitry 24 can be arranged to control and/or monitor a locked state of the electronic lock 18, i.e. locked or unlocked. The data storage means of the control circuitry 24 can further contain the unlock criteria which are to be satisfied in order to unlock the electronic lock 18. Alternatively, the unlock criteria may be stored in a storage means of the electronic lock 18 itself. Upon an update of the unlock criteria, the control circuitry 24 is configured to generate or relay new unlock criteria based on received or stored lock data. The previous unlock criteria may be deleted or simply rotated to the back of a queue or list of lock data.

The lock data may be received in bulk, for example prior to the container 10 being transported to a first destination, and stored in a data storage means of the control circuitry 24. Additionally or alternatively, the lock data may be received one by one via the receiver 20 after or during transport of the container 10 to a first destination. Storing the lock data in bulk allows the container 10 to update during transit without requiring a connection to a wireless communications network, thereby providing a more robust system. Receiving the lock data one by one ensures the lock data cannot be obtained from an attack on the container 10 and thereby improves the safety of the container 10.

As with the delivery data, the control circuitry 24 may have access to multiple sets of lock data that are used to update the unlock criteria upon, for example, an unlock-lock cycle of the electronic lock 18 or a detection of arrival of the container 10 at a predetermined location. A satisfaction of unlock criteria can cause said unlock criteria to be expired and the control circuitry may iterate to the next stored lock data. In this way, the unlock criteria may be updated based on the lock data. Configuring the control circuitry 24 is this manner allows the container 10 to be opened a set number of times and have its security controlled throughout transport. Moreover, as mentioned above, by internally generating an update of the unlock criteria in this way, it is not necessary to rely on an external communication to the container 10 to cause an update instruction, which may be difficult in remote locations.

The term unlock criteria is used to refer to the set of one or more criteria that each need to be satisfied in order for the electronic lock 18 to unlock. The unlock criteria may be updated based on lock data. For example, lock data can comprise a passcode, an encryption key, and/or a designated unlock location at which the electronic lock 18 unlocks. A selection from this set can be included in the unlock criteria, such as a passcode and an unlock location, so that the electronic lock 18 only unlocks upon entry of the passcode if the container 10 is also within a radius of the unlock location. Use of several unlock criteria further enhances the security of the container 10.

A further example of unlock criteria is a barcode such as a two-dimensional barcode, ‘QR’ code or the like that is displayed on the display 16. In this example, a user can employ a user device to scan or image the barcode and thereby trigger a data exchange with a communications network to obtain unlock data to cause the electronic lock 18 of the container 10 to adopt the unlocked state. Alternatively, the barcode can be displayed on the user device for identification by scanning or imaging means provided in the container 10, the barcode may be sent to the user device by a communications network or the like.

Lock data may be stored in data storage means of the control circuitry. For example a number of potential unlock criteria, such as a set of possible passcodes or unlock locations, can be stored and iterated between. That is, each set of lock data corresponds to potential future unlock criteria.

Unlock data can then be provided to the container 10, for example via the receiver 20, in order to contribute to a satisfaction of unlock criteria. In some examples, unlock data is the same as lock data, e.g. the lock data represents a passcode and the unlock data is that same passcode. In other examples, the unlock data is different but complementary to the lock data, for example an asymmetric pair of encryption keys. Unlock data may additionally or alternatively be provided directly to the electronic lock 18 via some input means such as a keypad or touchscreen.

For example, a recipient of the container 10, provided with necessary unlock data, can unlock the electronic lock 18 to access the contents of the enclosure 12. Then, upon said unlocking or upon a subsequent closing of the closure 14 and locking of the electronic lock 18, the unlock criteria are updated. The recipient, then becoming a sender, cannot use the same unlock data previously provided to them because the unlock criteria for the container have been updated to new unlock criteria, that do not correspond to the previous unlock data. Therefore, the security of the container 10 is maintained throughout the receiving, opening, closing, and sending process.

Alternatively, each update of the unlock criteria can be triggered by receipt of lock data and/or delivery data at the receiver 20. Alternatively, an update instruction that does not comprise lock data can trigger an update to unlock criteria based on stored lock data. For example, an external, potentially remote communications network (discussed in more detail below) can communicate an update instruction to the container 10 that causes the control circuitry 24 to iterate to the next set of stored lock data (previously received by the container).

Alternatively, lock data and/or delivery information can be provided as part of the update instruction communicated to the container 10 and the unlock criteria can be updated based on the newly received lock data. This approach advantageously removes a requirement for the control circuitry 24 to store lock data.

In one example, the reusable delivery container 10 can contain a location sensor and the lock data can represent an intended delivery location. As the container 10 is programmed with new delivery information, specifying a delivery address, or otherwise, corresponding lock data can be provided or generated from the delivery information. Then, when the location sensor detects that the delivery container 10 is within a predetermined radius of the intended delivery location (for example 20 metres, 50 metres, 100 metres or more or less based on the specific circumstances), the unlock criteria, updated based on the lock data corresponding to the location, will be satisfied and the electronic lock 18 will unlock. That is, the unlock data comprises a signal indicating that the location sensor has arrived within a radius of an unlock location. Larger radii may be of use in less built up areas, whereas closer radii may be more appropriate in built up areas.

Notably, this is one of a number of examples where the recipient is not explicitly involved in the unlocking of the container 10. Therefore, this may be advantageously applied to circumstances in which the recipient is not a known person but instead, for example, a business or a delivery depot which handle many packages at a time and so do not have the capacity or ability to unlock all of the containers but still desire a low-cost and secure delivery means. Use of such an opening container upon delivery to a location removes the requirement for specific container openers or opening systems.

The power circuitry 22 is configured to provide power to the electronic components of the reusable delivery container 10. For example, the power circuitry 22 can include a power input portion for connection to a power mains, a battery, a capacitor, or other power source. The power input portion can comprise an electrical port for insertion of a power cable.

Alternatively, the power input portion can comprise electrical contacts externally located and configured to abut a complementary set of powered electrical contacts so as to communicate power through the power input portion and into the power circuitry toward the electrical components. With this approach the container 10 can be conveniently powered by placement into appropriately configured racks, having such electrical contacts installed therein.

In some examples, the power circuitry 22 can include a power storage module such as a battery, a capacitor, or the like. In these examples, the power storage module can be rechargeable and the power input portion can be used to charge the power storage module with enough power to sustain the electronic components throughout the length of an expected use of the reusable delivery container.

The power circuitry 22 can be provided with solar panels, gyroscopic or kinetic charging, or other charging means that do not require a direct electrical power source to charge.

Furthermore, the power input portion can comprise a wireless charging means, such as inductive charging (for example a Qi® interface), that can draw power from an electromagnetic input. This would advantageously increase the resilience of the container 10 by removing an exposed electrical port from the outside of the container 10.

It is not necessary for all examples of the present invention to include a power storage module because, as discussed above, an electronic ink screen does not require a large amount of power to maintain displayed information. By not including a power storage module, the weight and cost of the reusable delivery container 10 can be further reduced.

In some examples, the container 10 can draw power through inductive charging means when in the range of an appropriately configured user device. In these examples, a user can position their device within range of the inductive charging means of the container 10 and thereby power the container 10. The control circuitry 24 may then update the unlock criteria of the electronic lock 18 and/or the displayed delivery information of the display 16. In some examples, the device may simultaneously exchange data communications with the receiver 20, such as lock data and/or delivery data. Although the aforementioned inductive charging means may struggle with high power scenarios, the display 16 advantageously employs low-power electronic ink. Thus, only a small amount of power is required to reconfigure the display 16, making the above described inductive charging means particularly convenient.

FIG. 1B shows a perspective view of a reusable delivery container 110 according to an example of the present invention. The reusable delivery container comprises a main body 126, in the specific example shown a cuboidal box that encloses an enclosure (not shown). The main body 126 is sealed by a closure 114; in the specific example shown, the closure 114 is a lid for the cuboidal box.

As shown in FIG. 1B, the reusable delivery container 110 has a display 116 attached to an outer surface of the container 110, facing outwards, with delivery information 128 displayed thereon. The display 116 is the same or similar to the display 16 shown in FIG. 1A. Whilst the display 116 is shown as being positioned on a portion of the outer surface of the main body of the container 110 in FIG. 1B, other arrangements are possible. For example, it is also possible for the display 116 to be positioned on the outer surface of the closure 114 or any position that would be convenient for integration into a delivery service.

In the illustrated example, the delivery information 128 comprises an address 130 and a one-dimensional barcode 132 but any form of delivery information may be displayed. For example, a two-dimensional barcode, such as a ‘QR’ code, or any representation of information that is able to communicate to a postal service, courier, or other delivery service the intended destination for the container. It is common for delivery service providers to employ barcode scanners in their package processing so it may be preferable for the display 116 to have appropriately configured display settings (contrast, brightness and the like) for ease of reading by a barcode scanner (or other computer vision).

In the illustrated example, the delivery information 128 is displayed using configurable electronic ink. As discussed above, by employing electronic ink, the power usage of the reusable delivery container 110 can be greatly reduced.

Whilst not shown, the container 110 in FIG. 1B also includes an electronic lock such as electronic lock 18 from FIG. 1A, a receiver such as the receiver 20 from FIG. 1A, power circuitry such as the power circuitry 22 from FIG. 1A and control circuitry such as the control circuitry 24 from FIG. 1A.

The walls that constitute the main body 126 of the container 110, as well as the closure 114, may be made of any material that would be suitable for secure storage without excessive cost or weight. The person skilled in the art would appreciate a balance between thickness and density of a material providing security but also increasing weight and cost to manufacture and transport the container 110. For example, the main body 126 and/or closure 114 can be made of injection-moulded plastic to reduce the weight of the container 110 whilst still providing suitable security and protection for the item. However, this might be more easily breached and thus less suitable for higher value items. Similarly, the main body 126 and/or closure 114 can be made out of sheet metals such as aluminium or steel, assembled with rivets, welding, or other means. This provides an increased security and protection for the item but would weigh more and therefore may cost more for delivery services to deliver the container 110.

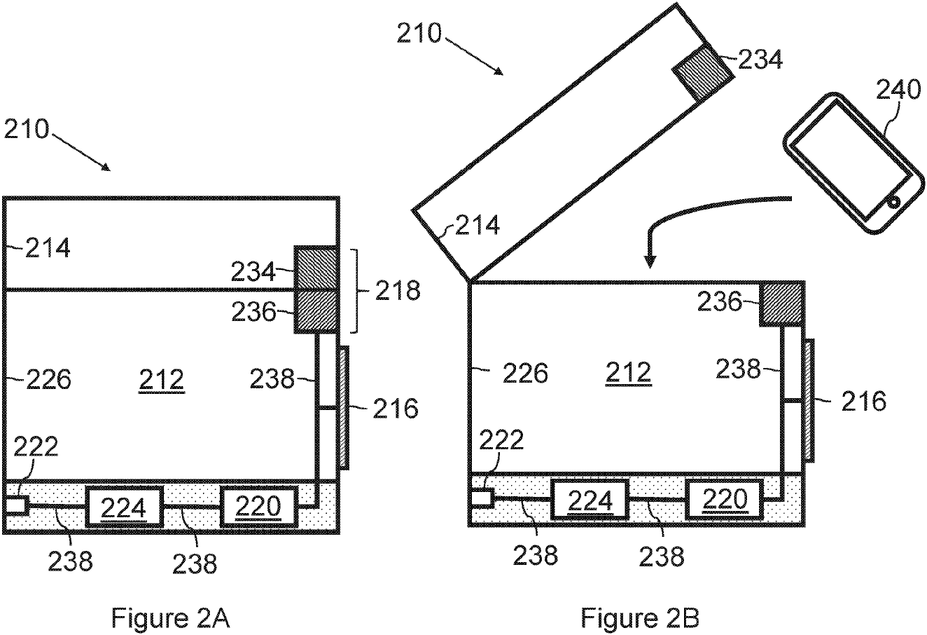

FIG. 2A shows a schematic cross-section of the reusable delivery container 110 from FIG. 1B. The delivery container 210 comprises an enclosure 212, a display 216, an electronic lock 218, a receiver 220, power circuitry 222, and control circuitry 224.

Whilst the display 216 is shown extending from the surface profile of the container 210, it is also possible to recess the display 216 into the side of the container 210 so as to achieve a seamless surface profile, which is less prone to damage during transport. To this effect, the display 216 can also be covered with a protective screen that is at least partially transparent so as to protect the display 216 whilst still allowing delivery information (not shown) displayed thereon to be read by a human or computer vision. For example, the display 216 may be protected by a sheet of resilient plastic or a metal wire mesh. This may also allow for greater weather resistance.

The electronic lock 218 is configured to secure the closure 214 of the reusable delivery container 210. In the illustrated example, the electronic lock 218 comprises locking members 234 and 236 that are configured to engage so as to secure the closure 214 in a closed position. The electronic lock 218 may have its locking state controlled electronically.

For example, the locking member 234 may include a projection and the locking member 236 may include a recess for receiving and retaining the projection in position until receipt of an electronic signal causes the locking member 236 to release the projection. In an example, the projection may be a buckle or the like. Additionally or alternatively, the locking members 234 and 236 can include an electronically controllable magnetic lock.

Whilst the electronic lock 218 is shown contained and concealed within the volume of the container 210, the electronic lock 218 may alternatively be installed on an external surface of the reusable delivery container 210 in a manner that facilitates the locking of the closure 214 in a closed position until satisfaction of unlock criteria.

In the specific example shown in FIG. 2A, the display 216, electronic lock 218, receiver 220, power circuitry 222, and control circuitry 224 (collectively ‘electronic components 216, 218, 220, 222, 224’) are connected by connective circuitry 238. In some examples, the reusable delivery container 210 comprises one or more sections for the placement of connective circuitry 238 and other electronic components 216, 218, 220, 222, 224. In the illustrated delivery container 210 of FIG. 2A, there is a section at the base of the container 210 in which electronic components 216, 218, 220, 222, 224 are placed. In another arrangement, these electronic components 216, 218, 220, 222, 224 may be mounted on an interior wall of the enclosure 212, embedded within the side walls of the container 210, or elsewhere such that the components 216, 218, 220, 222, 224 are protected from damage during use. As will be readily appreciated, it would be beneficial to install components 216, 218, 220, 222, 224 and circuity 238 in a manner that allows for easy maintenance or repair. Therefore, although not illustrated, the delivery container 210 may have one or more removable panels or access points for accessing the electronic components 216, 218, 220, 222, 224.

In the illustrated example of FIG. 2A, the power circuitry 222 is proximal to an external surface of the main body 226 of the container 210 so that it can be easily connected to an external power source.

The enclosure 212 is illustrated simply in FIG. 2A as the inside of a container 210, enclosed by main body 226 and the closure 214, i.e. the lid of the container 210. The enclosure 212 may further comprise stabilising components configured to stabilise items placed into the enclosure 212 during transport. For example, one or more biasing members, such as springs, may extend from the internal walls of the enclosure 212 so as to push the item against internal walls or opposing biasing members, thus holding the item in place during transfer.

Alternatively or additionally, the enclosure 212 may comprise an insert that is conformed to the shape of the item, for example a foam insert having a cut out that complements the shape of the item to be received or a memory foam insert that conforms to the shape of the item when the item is pressed against the surface of the memory foam.

The interior walls of the enclosure 212 can be padded with a resilient material such as rubber or foam so that impact of the item against the interior walls of the enclosure 212 during transport does not damage the item.

FIG. 2B shows the reusable delivery container 210 from FIG. 2A with the closure 214 opened to receive an item 240, in this case a mobile phone.

Whilst only one item 240 is shown, it is possible that the container 210 could be configured to receive and contain multiple items like item 240 or different to item 240. For example, the multiple items 240 can be stored in respective compartments or shelves of the container 210. Whilst electronic devices are referred to throughout by way of example, the reusable delivery container 210 can be used for any item or items of value. Indeed, the container 210 can be used to transport money, cash or the like which are to be considered as items of value.

In an example use case, the electronic lock 218 can be unlocked by satisfaction of the unlock criteria so that the closure 214 opens. In some examples, the closure 214 is biased toward an opening position, by one or more springs, opposing magnets or other biasing means, so that an unlocking of the electronic lock 218 leads to a sufficient opening of the closure 214 to prevent re-engagement of the locking members 234 and 236 of the electronic lock 218. This way, a user will have to apply force to re-engage the locking members 234 and 236. In cases such as those where unlock criteria may update in response to a locking of the electronic lock 218, this can prevent an accidental locking out of the user from the container 210.

The illustrated example shows a hinged container opening about a hinged attachment between the closure 214 and the main body 226 of the container. However, the closure 214 may be slidably, rotatably, magnetically or otherwise attached to main body 226 and may comprise an entire wall of the container 210 or only a portion of a wall. For example, the closure 214 can comprise a letterbox-shaped slot in a wall of the container 210 that is closed by sliding a plate thereacross. Alternatively, the closure 214 can comprise a zippered side of the container 210. It is possible to tailor the arrangement of the closure 214 and how it is opened or closed to the particular circumstances at hand.

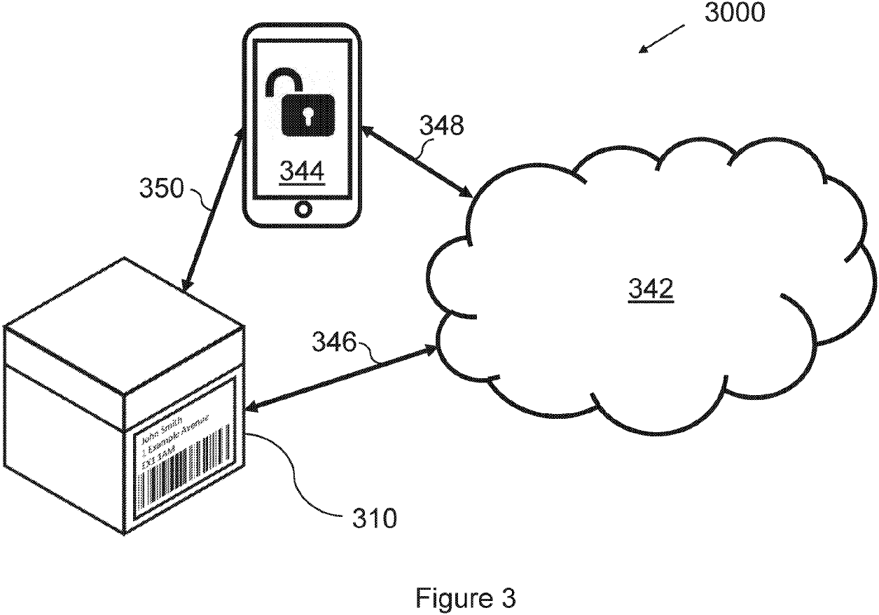

FIG. 3 shows a delivery system according to a further example of the present invention. Where similar (or the same) features are shown in FIG. 3 as to those features in FIGS. 2A and 2B, the numerals have been increased by 100. Where the function of these is the same, these may or may not be described herein for improved readability.

According to one example, the delivery system 3000 comprises a reusable delivery container 310, a wireless communications network 342 and, optionally, a user device 344.

The reusable delivery container 310 and the wireless communications network 342 are configured to communicate with each other via wireless communication protocols, such as those discussed in the forgoing or other wireless communication means. These communications are indicated graphically in FIG. 3 as line 346.

The wireless communication network 342 can exchange data communications with a user device 344, as indicted by line 348. The user device 344 can be a mobile phone, a tablet, a personal computer, a smart device, or any such device that is capable of wirelessly exchanging data communications. In some examples, the user device 344 has an application downloaded thereon that facilitates communications between the user device 344 and the wireless communications network 342. For example, the wireless communications network 342 may be managed by a delivery co-ordinator who provides an application for management and tracking of deliveries and/or unlocking of the container 310.

The user device 344 may be further configured to exchange communications with the delivery container 310, indicated by the line 350. For example, the user device 344 may be configured to generate complementary unlock criteria and/or receive complementary unlock criteria, complementary to the unlock criteria of the electronic lock, from the wireless communications network 342 and provide it to the receiver of the delivery container 310 via NFC or other communications technology so as to unlock the container 310. For example, the user device 344 can provide a complementary part of an encryption key to the container 310 which the control circuitry of the container may verify to establish that unlock criteria have been satisfied.

In some examples, an update to the unlock criteria will be triggered by an update instruction and the wireless communications network 342 will communicate lock data to the receiver (via a user device or directly) and communicate complementary unlock data to a user device 344 of the recipient so that the recipient can unlock the container 310 with the updated unlock criteria.

In a particular example, the wireless communications network 342 can provide a passcode to the electronic container 310, which updates the unlock criteria for the electronic lock. The wireless communications network 342 also communicates this passcode to the user device 344 so that a user, e.g. a recipient of the container, can enter the passcode into some entry means of the electronic lock to unlock the container 310.

Once the lock data has been communicated to the receiver, the control circuitry may be configured to update unlock criteria of the electronic lock based on lock data. For example, the lock data can be a password, a private key, or similar, which is provided to the recipient in advance of or in parallel with the delivery of the container 310 to the recipient.

In some examples, for example in the case of a password, the same data is communicated to the reusable delivery container and the recipient. That is, the container 310 may have its password updated to correspond to the new password from the lock data such that the recipient, being also provided with this updated password, can unlock the delivery container 310 upon receipt.

In an example, the unlock criteria are updated at each stage of delivery from a sender to a recipient, so that, upon sending the container 310, the sender becomes ‘locked out’ of the container 310 and only those in possession of the updated unlock information can open the container 310. Advantageously, this means that the delivery service handlers that transport the container to the recipient do not have access to the contents therein, thus improving the security of the delivery system.

Whilst in the above discussion, an updated password has been referred to, it is noted that there are many ways in which the container 310 can be locked, unlocked, and have its unlock criteria changed whilst still falling within the scope of the claims.

In another example, the lock data comprises one half of an asymmetric pair of encryption keys while the other half is provided to a user in the form of unlock data. The lock data can be provided to the delivery container 310 directly via long-range wireless communications from the wireless communications network 342 or via a user input device 344 belonging to a sender, for example as part of the locking process for the container 310.

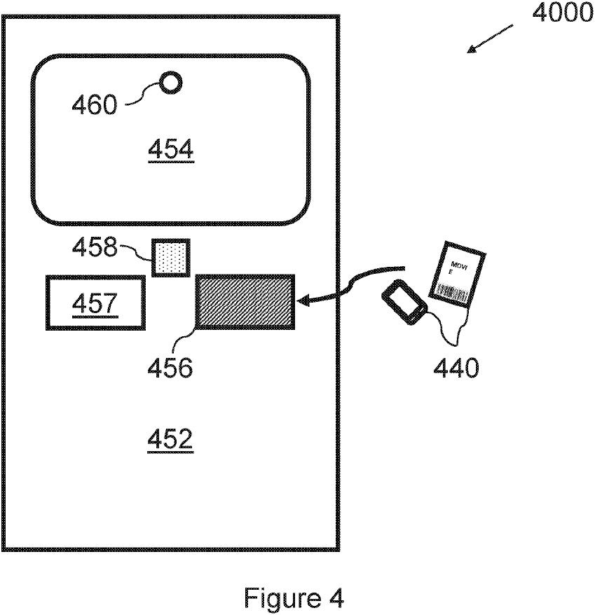

FIG. 4 shows an item deposition unit, according to an example of the invention. As illustrated, item deposition unit 4000 has a casing 452 and a screen 454 for displaying information. In some examples, the screen 454 is a touch screen. The item deposition unit 4000 further comprises at least one item deposition channel 456 configured to communicate items to an enclosure of a container (not shown) and management circuitry 457 configured to exchange data communications with a receiver of the container. The container or plurality of containers in the unit 4000 may be as described above. The item deposition unit 4000 facilitates items 440 being deposited into containers. In the illustrated example, the item deposition unit 4000 further comprises a reader 458 configured to collect information about items 440 and a camera 460.

The casing 452 is configured to at least partially surround a cavity (not shown) so as to provide additional security to reusable delivery containers arranged within the cavity.

In some examples, a screen 454 is provided as part of the item deposition unit 4000 to display instructions or guide a user through a transaction. For example, the screen 454 may display instructions telling a user to deposit items 440 into the item deposition channel 456. Additionally or alternatively, the screen 454 can display a valuation of items 440 representative of an amount of money, or estimated amount, to be paid to the user in exchange for depositing the items 440. In some examples, the screen 454 may be a touch screen. In these examples, the touch screen may be used by a user to input information about the items 440 being deposited. The touch screen may also be used by a user to accept or reject a valuation for items 440.

The at least one item deposition channel 456 is shown as an opening in the casing 452. In practice, the item deposition channel 456 can be any throughput such as a window, a narrow corridor, a chute, a slide, or the like suitable to communicate items 440 from an exterior of the casing 452 to the enclosure of the at least one delivery container. The item deposition channel 456 may include an opening toward an exterior of the casing 452, where the user may deposit items 440, and another opening toward the cavity of the casing 452, directed toward an enclosure of a container in the cavity. One opening, such as the interior opening, of the item deposition channel 456 may be movable relative to an enclosure of a container. Therefore, items 440 may be selectively deposited into different portions of a container or different containers in the recess. Relative movement enables controllable, and therefore accurate, deposition of goods 440 into contains in the unit 4000.

The management circuitry 457 may be any circuitry suitable for controlling the electronic components of the item deposition unit 4000. In some examples, the management circuitry 457 is configured to provide lock data, an unlock location, an unlock update instruction and/or a delivery information update instruction (the latter two collectively ‘update instructions’) to the receiver of the at least one reusable delivery container. The management circuitry 457 may also be configured to generate a selection message to direct the opening of the item deposition channel 456 toward the closure of a particular container in the cavity. Advantageously, this means that items 440 can be grouped according to their properties. For example, high value items can be directed toward a more secure portion of an reusable delivery container, having stronger unlock criteria (such as a longer passcode or more factors of authentication). The management circuitry 457 may direct one item 440 to one enclosure and provide the closure for that enclosure with one set of unlock criteria, and subsequently the management circuitry 457 may direct another item 440 to another enclosure, having another set of unlock criteria.

The reader 458 may be a camera, a barcode scanner, or any other reader suitable for collecting information about items 440 and communicating the information to the management circuitry 457. The information collected may be an identity of an item 440, such as a DVD in a DVD case, identified by a barcode displayed on the DVD case. While, more accurately, such a check would confirm the case of the DVD rather than the DVD itself, the system provided herein may have subsequent additional checks to confirm the DVD corresponds to the case of the DVD. Alternatively, the reader may or include be a DVD reader which is able to scan the DVD and confirm the disc prior to receiving the disc.

In some examples, the reader 458 may be arranged in the item deposition channel 456. For example, the reader may be installed on a surface in the proximity of the item deposition channel 456 so that information is collected about items 440 simultaneously to their being deposited into the item deposition channel 456. In a particular example, the item deposition channel 456 may be a chute having a reader 458 arranged at some intermediate position along the length of the chute. Advantageously, this would confirm the identity of an item 440 being placed into the reusable delivery container at a point where the user will no longer be able to retrieve the item 440. This increases the system’s ability to resist fraudulent attempts at use.

In some examples, the reader 458 may collect one or more images of the items 440 and apply one or more machine learning algorithms to the images in order to identify the items 440 shown in the images, e.g. the type or identity of the items 440. The type of an item is, for example, a mobile phone, a tablet, a laptop, a power tool, etc. whilst the identity of an item is its particular make or model, e.g. iPhone®, iPad®, etc. The one or more machine learning algorithms may be further configured to determine a condition of the items. For example, the machine learning algorithms may determine that type of an item 440 is a mobile phone and/or the identity of an item 440 is an ‘iPhone ® 8’ and/or that the condition of the item 440 is ‘almost new’ or a ‘7/10’ quality factor or use some other quantitative or qualitative grading system. Advantageously, this information can further improve the security of the system as any third party courier services will be liable for causing any further damage to the item 440 and/or exchanging the item for a similar but lower value item 440 such as, e.g., an ‘iPhone ® 7’.

A camera 460 may be provided on the casing 452, for example on the screen 454 of the casing 452 as in the example shown in FIG. 4. The camera 460 can be used for security purposes to capture images of users in case of a security breach of the item deposition unit 4000.

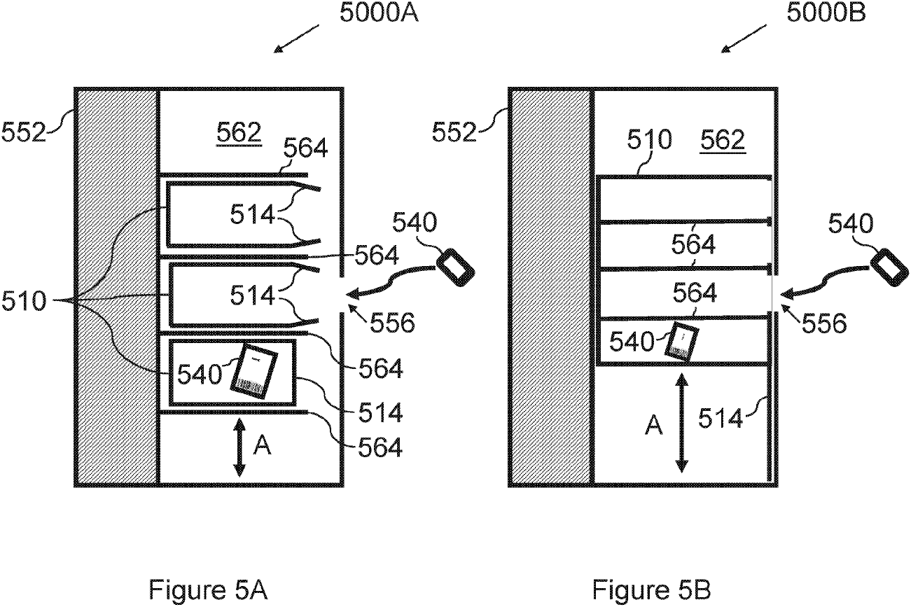

FIG. 5A shows a side-on schematic view of the item deposition unit of FIG. 4, according to an example of the invention. In the illustrated example, the item deposition unit 5000A includes a casing 552 and item deposition channel 556 that are the same or similar to those as discussed with reference to FIG. 4. The item deposition unit 5000A further comprises a cavity 562 within the casing 552 and a plurality of shelves 564 mounted in the cavity 562 and arranged to partition the cavity 562 and move relative to the item deposition channel 556. The axis of relative movement is shown by arrow A.

The shelves 564 are arranged to receive one or more reusable delivery containers 510 such as those described above. The delivery containers 510 each comprise closures 514, which may be for example hinged flaps. As shown in FIG. 5A, the item deposition unit 5000A contains three delivery containers 510, although there can be more or fewer. The upper two delivery containers 510 have their respective closures 514 open whilst the lowest delivery container 510 has its closure 514 closed and contains an item 540.

In use, an item 540 is placed into the item deposition channel 556 and directed into a specific container 510 of the one or more containers. The container 510 that the item 540 is directed into may be the next container with capacity 510 (volume or weight). Alternatively, the management circuitry (not shown) may select which container 510 the item 540 should be directed toward. This selection may be based on information provided to the management circuitry by the reader or based on information provided by the user via a touch screen.

In the illustrated example, there are three containers 510. Therefore, each container 510 may be provided with different delivery data and/or unlock criteria, which may be based on the contents therein, and transported to different locations. Advantageously, this provides the option to send higher value containers 510 (containers 510 containing higher value items 540) to a courier for onward sale, whilst sending lower value containers 510 to a recycling plant for environmentally friendly disposal of the items 540.

The closures 514 of the containers 510 may be closed and/or locked in response to a detection that they are full, that they contain a predetermined value of items 540 or another other signal. Alternatively, the containers 510 may be manually closed, having unlock criteria for their electronic locks provided to them from the item deposition unit 5000A.

FIG. 5B shows a side-on schematic view of the item deposition unit of FIG. 4, according to another example of the invention. Like-numbered elements are the same or similar to those shown in FIG. 5A and some of these elements are not discussed further for the sake of brevity.

Item deposition unit 5000B is similar to the item deposition unit 5000A of FIG. 5A. However in the specific example shown in FIG. 5B, there is only one container 510 contained in the cavity 562. Furthermore, the shelves 564 of FIG. 5A take the form of partitions within the delivery container 510 to separate different items 510 contained therein. The container 510 is movable relative to the item deposition channel 556 so that a different shelf or partition 564 can be presented to an opening of the item deposition channel 556. The closure 514 is provided, in the specific example shown, as a plate slidably engaged with openings of the enclosures of the container 510 so that a movement of the container 510 relative to the closure 514, will open or seal the enclosures. This closure 514 may be secured with an electronic lock as discussed above.

In use, the container 510 may be sealed and locked using the closure 514. The container 510 may then be secured by an electronic lock having updatable unlock criteria. A display (not shown) on the container 510 may be updated to display delivery information based on delivery data corresponding to an intended destination. The container 510 may be securely shipped or transported to the intended destination using the delivery information and opened at the intended destination by satisfaction of the unlock criteria. As such, there is provided herein a secure and reliable delivery system which can be integrated with any third party delivery services. Also provided herein is an item deposition unit with is also both secure and reliable.

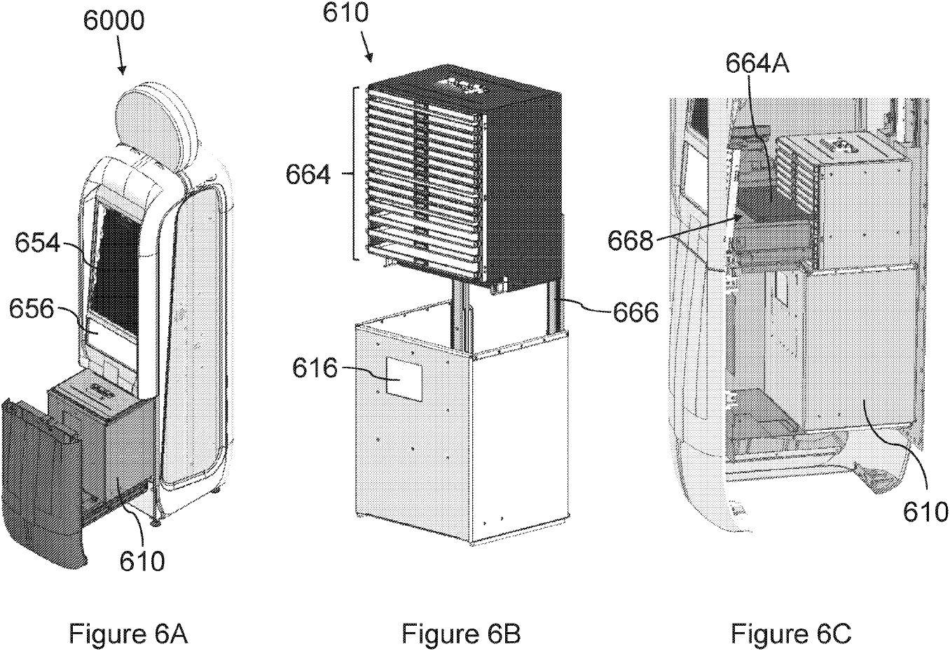

FIGS. 6A-6C show an example item deposition unit 6000 and reusable delivery container 610.

In the illustrated example of FIG. 6A, an item deposition unit 6000 has a reusable delivery container 610 removably placed therein. As can be seen in the exploded view of the container 610 from FIG. 6B, the container 610 has a series of shelves, or partitions, 664 mounted on a rack system 666 so that the shelves 664 are movable relative to an item deposition channel 656 of the item deposition unit 6000. The item deposition channel 656 may be sized so as to receive a large range of items from small, regular shape electronics such as mobile phones to large, irregular shape electronics such as games consoles or power tools or the like.

As shown in FIG. 6B, some of the shelves 664 have different dimensions to other shelves 664 in the system. Advantageously, the shelves 664 of the container 610 can then account for different sized items. For example, the larger shelves 664 can receive larger items such as games consoles, power tools, or other larger items of value, whilst the smaller shelves 664 can receive smaller items such as mobile phones, small tablets, or other smaller items of value. Also shown in FIG. 6B is a display 616 of the container.

FIG. 6C shows a cross-sectional view of the item deposition unit 6000 of FIG. 6A. The rack system 666 of the delivery container 610, shown in FIG. 6C, has moved the shelves 664 toward the item deposition channel 656. In the illustrated example, there is an escrow area indicated by the arrow 668. The escrow area 668 can be arranged between the item deposition channel 656 and the shelves 664 of the container 610 so that a shelf 664A of the shelves 664 can be extended into the escrow area 668 and a user can place an item through the item deposition channel 656 and onto the shelf 664A. Advantageously, this ensures that an item is received into the delivery container 610 and, for example, into a specific suitable shelf 664A of the shelves 664.

A reader (not shown) similar to the reader 458 can be directed toward the escrow area 668 so that an item placed onto a shelf 664A in the escrow area 668 can be imaged or otherwise have information collected about it. In this way, the item deposition unit 6000 can be configured so that the shelf 664A is only retracted from the escrow area 668 once information about the item contained in the shelf 664A is confirmed and/or a transaction with the user depositing the item has been completed. This further enhances the security of the item deposition unit. For example, user deposition then removal of an item from the unit 6000 is significantly hindered by the present arrangement.

In some examples, the collected information may include one or more images taken of the item by reader and the management circuitry may apply a machine learning algorithm to the one or more images in order to inform which shelf or partition of the shelves/partitions 664 the item should be placed into. The machine learning algorithms may be trained to identify, from an image of an item, the identity and/or condition of the item. The management circuitry of the item deposition unit 6000 may then employ a database of known dimensions/weights to determine the weight or volume of the item.

As an example, an item may be placed through the item deposition channel 656 and into the escrow area 668 of the unit 6000. Then, the reader, taking the form of a series of cameras in this example, may image the item, for example from multiple angles in order to compile a comprehensive view of the item. These images may then be input into a machine learning algorithm which identifies the item as being an iPhone® 8. The management circuitry then determines, from a database of known items, that the iPhone® 8 weighs 148 grams and/or that the dimensions of the iPhone® 8 are 67.3 × 138.4 × 7.3 millimetres. Based on this information, the management circuitry may select, by way of a selection message, a particular shelf 664A of the shelves 664. An advantage of employing a database and machine learning algorithms is that the unit 6000 need not be provided with direct measuring means and thus is cheaper and easier to manufacture and maintain.

Additionally or alternatively, the unit 6000 may comprise weighing means and/or other measuring means to directly measure information such as weight and dimensions of items presented to the unit 6000. Advantageously, this means that the unit 6000 can select an appropriate shelf 664A for an item even if that item is not known in a database and/or cannot be identified by machine learning algorithms.

An advantage of providing selectable partitions in the container 610, such as the shelves 664, is that the weight distribution of the container 610 can be controlled. For example, a first item may be placed into a central shelf so that, if it were the only item to be in the container 610 when it is eventually delivered from the unit 6000, the weight will be centrally distributed in the container 610. Alternatively, a lowest shelf may be selected so that the container 610 is bottom-heavy and thus more stable during deliveries.

Each time an item is added to the container 610, the selected partition or shelf 664 of the container 610 may be chosen on the basis of the desired weight distribution. For example, if the weight of an item is known or measured using the techniques described above, the weight distribution of the container 610 can be finely controlled by selecting which shelf the item is to be placed into.

In some examples, the weight distribution may be tailored so that there is an even weight distribution throughout the container 610. This advantageously makes the container 610 easier to manually handle and carry. In other examples, the weight distribution may be tailored so that there is a deliberately uneven weight distribution, which may bias the container 610 toward a particular orientation. This particular orientation may be selected so that the display of the container is more likely to face a preferred direction when the container 610 is being processed by a delivery service. Such an uneven weight distribution may be likened to a loaded die, which is biased toward landing with a particular side facing upward. In automated delivery systems, a container 610 may be jostled and rolled during processing, giving the uneven weight distribution an opportunity to bias the orientation of the container 610 like a loaded die.

Whilst the above discussion relates to a ‘real-time’ sorting of items, it is also possible for the unit 6000 to shuffle or rearrange items between shelfs after the fact. For example, the management circuitry of the unit 6000 may be arranged to deposit items from one shelf of the shelves 664 into the escrow area 668 and collect the item from the escrow area 668 with another shelf of the shelves 664. This rearrangement or redistribution process may occur in response to an indication that the container 610 is full, or an indication that the container 610 is soon to be delivered from the unit 6000, or in response to some other indication, or periodically.

The items may be arranged on particular shelves on the basis of their physical dimensions such as volume or length as opposed to or in addition to their weight.

In an example, the partitions in the container, or elements of the container, may be modular. The partitions may be able to clip together so as to form a structure with a larger number of partitions which may be located within the container. In such a way, if the container is provided with only three items for delivery, the container may only have three partitions. In such a way, the additional but unnecessary partitions are not transported with the container. In such a way, the weight of the container can be reduced to that which is required for the delivery journey selected. This advantage is a result of the modular build option of the present system. In an example wherein, e.g. nine items are to be delivered, three partition structures (each with three areas for containing items) may be clipped or secured together and located within the container. This flexibility may be used by the user to ensure particularly efficient transportation both in terms of size and fuel or energy required for transportation.

The shelves 664 can be lowered into the delivery container 610 by the rack system 666 or by other means and the delivery container 610 can be secured with an electronic lock (not shown) similar to the electronic lock 18, 218 described above. The display 616 of the container 610 can then display delivery information received from the item deposition unit 6000 or from elsewhere in a manner similar to that described previously.

Whilst the above discussion has referred to an item deposition unit for depositing items, those skilled in the art will appreciate that the disclosed system can also be described and used as an item collection unit for collecting items without departing from the scope of the appended claims. When used as an item collection unit, taking for example the unit 6000 of FIGS. 6A-6C, the shelves 664 can be selectively positioned relative to the item channel 656 and a shelf 664A can be extended into the escrow area 668 whilst containing within it an item for collection by the user. It is possible that this item was previously deposited at the unit 6000 by another user as part of a transaction.

By functioning as an item deposition and item collection unit, the above described systems can integrate into a broader delivery network wherein reusable delivery containers such as the reusable delivery container 610 are securely delivered to and from item deposition units such as item deposition unit 6000 by users or couriers or other third party postal services.

As such there is disclosed herein, a reusable delivery container comprising: an enclosure for containing an item; a closure selectively allowing access to the enclosure; a display on an outer surface of the container, comprising configurable electronic ink for displaying delivery information; an electronic lock for selectively securing the closure, the electronic lock having updatable unlock criteria; a receiver configured to receive data communications, the data communications comprising at least lock data; power circuitry for providing power from a power source to the display, the electronic lock, and the receiver; and control circuitry arranged to control the electronic lock and update the unlock criteria, based on lock data received by the receiver.

1. A reusable delivery container comprising:
an enclosure for containing an item;
a closure selectively allowing access to the enclosure;
a display on an outer surface of the delivery container, comprising configurable electronic ink for displaying delivery information;
an electronic lock for selectively securing the closure, the electronic lock having updatable unlock criteria;
a receiver configured to receive data communications, the data communications comprising at least lock data;
power circuitry for providing power from a power source to the display, the electronic lock, and the receiver; and
control circuitry arranged to control the electronic lock and update the unlock criteria, based on lock data received by the receiver.

2. The reusable delivery container of claim 1, wherein:
the receiver is further configured to receive delivery data,
the control circuitry is arranged to control the display, and
the control circuitry is further configured to update the displayed delivery information based on received delivery data.

3. The reusable delivery container of claim 1, wherein the electronic lock is configured to adopt an unlocked state in response to the receiver receiving unlock data that satisfies the unlock criteria.

4. The reusable delivery container of claim 1, further comprising a location sensor, wherein:
the unlock criteria comprise at least one unlock location, and
the control circuitry is configured to unlock the electronic lock upon a determination by the location sensor that the delivery container is within a predetermined radius of the at least one unlock location.

5. The reusable delivery container of claim 4, wherein at least one of:
the at least one unlock location; and
the predetermined radius of the at least one unlock location,
are provided as lock data to the receiver.

6. The reusable delivery container of claim 1, wherein:
the control circuitry comprises data storage means with one or more lock data stored thereon, and
the control circuitry is arranged to update the unlock criteria based on the one or more lock data stored on the data storage means.

7. An electronic delivery system comprising:
at least one reusable delivery container according to claim 6; and
an item deposition unit, wherein the item deposition unit comprises:
a casing at least partially surrounding a cavity, the cavity arranged to receive the at least one reusable delivery container;
an item deposition channel for communicating items from an exterior of the casing to the enclosure of the at least one delivery container; and
management circuitry configured to exchange data communications with the receiver of the at least one reusable delivery container.

8. The electronic delivery system of claim 7, wherein the management circuitry is further configured to provide lock data, an unlock location, unlock update instruction and/or delivery information update instruction to the receiver of the at least one reusable delivery container.

9. The electronic delivery system of claim 7, wherein the item deposition unit comprises a reader for collecting information about items and communicating the information to the management circuitry.

10. The electronic delivery system of claim 9, wherein the reader is arranged in the item deposition channel.

11. The electronic delivery system of claim 9, wherein:
the at least one reusable delivery container contains a plurality of partitions,,
the plurality of partitions of the at least one reusable delivery container and an exit of the item deposition channel are arranged to move relative to one another, and
the plurality of partitions and the exit of the item deposition channel move relative to one another in response to a selection message from the management circuitry to direct the exit of the item deposition channel toward a selected partition.

12. The electronic delivery system of claim 11, wherein the selection message is based at least in part on collected information from the reader.

13. The electronic delivery system of claim 11, wherein:
the collected information from the reader includes at least one image;
the management circuitry applies one or more machine learning algorithms to the at least one image to determine at least one of a type of an item, an identity of an item and a condition of an item; and
the selection message is based at least in part on an output of the one or more machine learning algorithms.

14. The electronic delivery system of claim 11, wherein at least a subset of the plurality of partitions is provided with a corresponding plurality of closures, at least one of the plurality of closures being provided with a different unlock criteria to at least one of the other of the plurality of closures.

15. An electronic delivery method comprising:
receiving one or more items at an item deposition station;
communicating the items to or from one or more reusable delivery containers, each of the one or more reusable delivery containers being a container according to claim 1 ;
locking the one or more delivery containers with updatable unlock criteria provided to the one or more containers;
providing delivery data to the one or more containers;
displaying delivery information on the one or more containers based on the delivery data; and
transporting the one or more containers to a first location corresponding to the delivery information.
